(19) United States
(12) Patent Application Publication
(10) Pub. No.: US 2007/0044778 A1
(43) Pub. Date: Mar. 1, 2007

(54) Engine which operates repeatedly with a multi-stage combustion process

(75) Inventors: Nebojsa Milovanovic, Norfolk (GB); James William Griffith Turner, Norfolk (GB)

Correspondence Address: FULWIDER PATTON, 6060 CENTER DRIVE, 10TH FLOOR, LOS ANGELES, CA, 90045, US

(73) Assignee: Lotus Cars Limited

(21) Appl. No.: 11/503,470

(22) Filed: Aug. 11, 2006

(30) Foreign Application Priority Data
Sep. 1, 2005 (GB) GB0517800.9

(51) Int. Cl. F02M 25/07; F02B 47/08; F02B 75/20

(52) U.S. Cl. 123/568.14; 123/58.8

(57) ABSTRACT

With reference to FIG. 1, the present invention provides an internal combustion engine which operates repeatedly a multi-stage combustion process, the engine having a combustion chamber, supply means (12) for supplying fuel and air to the combustion chamber and exhaust means (16) for exhausting combusted gases from the combustion chamber. During a first stage of combustion (FIG. 1(a)- FIG. 1(c)) the supply means (12) supplies fuel and air to the combustion chamber and the supplied fuel and air are combusted by a spark ignition Otto process or by a compression ignition Diesel process. Then (FIG. 1(d)) at least a majority of the combusted gases resulting from the first stage combustion are retained in the-combustion chamber, additional air is supplied to the combustion chamber(FIG. 1(e)) and the resulting mixture is combusted in a second combustion stage (FIG. 1(e) and FIG. 1(f))by homogeneous charge compression ignition. The mixture of fuel and air during the first stage combustion is a rich mixture (with an air-fuel ratio λ less than 1) and the mixture of fuel and air and combusted gases during the second stage of combustion is a weak mixture (with an air-fuel ratio λ greater than 1).

The present invention relates to an engine which operates repeatedly a multi-stage combustion process, e.g. in a six, eight or more stroke cycle, the strokes grouped into a number of stages. In particular, it relates to an engine for heavy duty or power generation application, e.g. electricity generation.

Conventional internal combustion engines can typically operate with a two or a four stroke cycle. There is an increasing need to reduce emissions from such internal combustion engines, and there have been several different approaches to reducing emissions. The present invention tackles the problem of providing an engine with reduced emissions by providing in each engine cycle a multi-stage combustion process.

The present invention, in a first aspect, provides an internal combustion engine which operates repeatedly a multi-stage combustion process, the engine having a combustion chamber, supply means for supplying fuel and air to the combustion chamber and exhaust means for exhausting combusted gases from the combustion chamber, wherein:

during a first stage of combustion the supply means supplies fuel and air to the combustion chamber and the supplied fuel and air are combusted by a spark ignition Otto process;

then at least a majority of the combusted gases resulting from the first stage combustion are retained in the combustion chamber, additional air is supplied to the combustion chamber and the resulting mixture is combusted in a second combustion stage by homogeneous charge compression ignition; and

the mixture of fuel and air during the first stage combustion is a rich mixture (with an air-fuel ratio λ less than 1) and the mixture of fuel and air and combusted gases during the second stage of combustion is a weak mixture (with an air-fuel ratio λ greater than 1).

The present invention, in a second aspect, provides an internal combustion engine which operates repeatedly a multi-stage combustion process, the engine having a combustion chamber, supply means for supplying fuel and air to the combustion chamber and exhaust means for exhausting combusted gases from the combustion chamber, wherein:

during a first stage of combustion the supply means supplies fuel and air to the combustion chamber and the supplied fuel and air are combusted by a spark ignition Otto process;

then in each of a plurality of subsequent combustion stages at least a majority of the combusted gases resulting from the previous combustion are retained in the combustion chamber, additional air is supplied to the combustion chamber and the resulting mixture is combusted by homogeneous charge compression ignition, until after the last of the combustion stages the combusted gases are exhausted to atmosphere; and

the mixture of fuel and air during the first stage combustion is a rich mixture (with an air-fuel ratio λ less than 1) and the mixture of fuel and air and combusted gases during each subsequent stage of combustion is a weak mixture (with an air-fuel ratio λ greater than 1).

The present invention provides in a third aspect an internal combustion engine which operates repeatedly a multi-stage combustion process, the engine having a combustion chamber, supply means for supplying fuel and air to the combustion chamber and exhaust means for exhausting combusted gases from the combustion chamber, wherein:

during a first stage of combustion the supply means supplies fuel and air to the combustion chamber and the supplied fuel and air are combusted by a compression ignition Diesel process;

then at least a majority of the combusted gases resulting from the first stage combustion are retained in the combustion chamber, additional air is supplied to the combustion chamber and the resulting mixture is combusted in a second combustion stage by homogeneous charge compression ignition; and

the mixture of fuel and air during the first stage combustion is a rich mixture (with an air-fuel ratio λ less than 1) and the mixture of fuel and air and combusted gases during the second stage of combustion is a weak mixture (with an air-fuel ratio λ greater than 1).

The present invention provides in a fourth aspect an internal combustion engine which operates repeatedly a multi-stage combustion process, the engine having a combustion chamber, supply means for supplying fuel and air to the combustion chamber and exhaust means for exhausting combusted gases from the combustion chamber, wherein:

during a first stage of combustion the supply means supplies fuel and air to the combustion chamber and the supplied fuel and air are combusted by a compression ignition Diesel process;

then in each of a plurality of subsequent combustion stages at least a majority of the combusted gases resulting from the previous combustion are retained in the combustion chamber, additional air is supplied to the combustion chamber and the resulting mixture is combusted by homogeneous charge compression ignition, until after the last of the combustion stages the combusted gases are exhausted to atmosphere; and

the mixture of fuel and air during the first stage combustion is a rich mixture (with an air-fuel ratio λ less than 1) and the mixture of fuel and air and combusted gases during each subsequent stage of combustion is a weak mixture (with an air-fuel ratio λ greater than 1).

The invention has the advantage that emissions from the engine are significantly reduced compared to those emitted from a conventional spark ignition four stroke combustion process. The power output may also be increased, and specific fuel consumption reduced.

Preferred embodiment of the present invention will now be described with reference to the accompanying drawings in which:

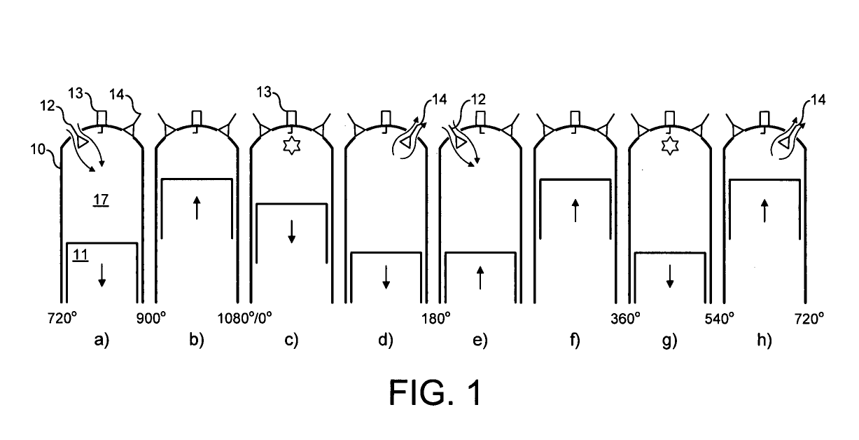

FIG. 1 illustrates as steps a) to h) a first multi-stage combustion process according to the present invention;

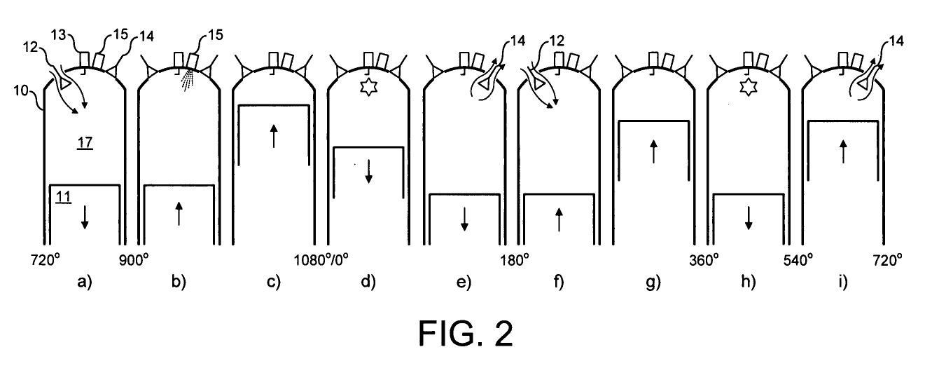

FIG. 2 illustrates as steps a) to i) a second multi-stage combustion process according to the present invention; and

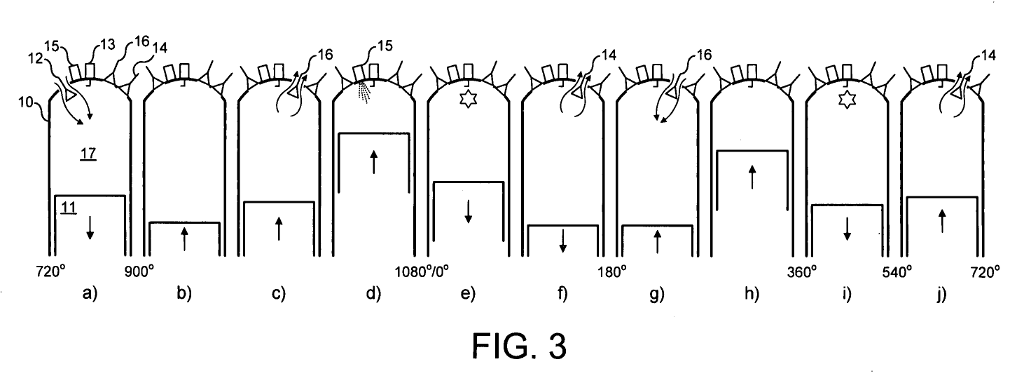

FIG. 3 illustrates as steps a) to j) a third multi-stage combustion process according to the present invention.

In FIG. 1 there is shown a piston 11 which reciprocates in a cylinder 10 and defines therewith a variable volume combustion chamber 17. An inlet valve 12 controls flow of charge air into the combustion chamber 17. An exhaust valve 14 controls flow of combusted gases out of the combustion chamber 17 through an exhaust passage which relays the exhausted gases to atmosphere. There is also shown a spark plug 13.

The valves 12 and 14 may be controlled by a variable valve drive system which allows the opening durations of the valves to be varied. The variable valve train driving the valves could comprise hydraulic actuators connected to the valves 12, 14 to cause the valves 12, 14 to open and close. The hydraulic actuators would be controlled by an engine management system. This type of system is well known in the art. Such a variable valve train would allow the engine to function in some operating conditions with a conventional four stroke Otto cycle, and under certain load and speed conditions with a multi-stage combustion process as will be described below.

For ease of explanation, the figures illustrate the operation of only one cylinder but the engine in which the piston 11 and cylinder 10 are located will have typically two or more additional cylinders with additional pistons reciprocating therein, the pistons all connected to the common crankshaft, and each cylinder having valves as described above. The engine may be a four cylinder engine, a six cylinder engine, an eight cylinder engine, etc,

The engine may be a heavy duty engine or an engine used for electrical power generation.

Turning now to FIG. 1, at 1(a) an intake stroke is shown, in which the inlet valve 11 is open to admit a charge of a fuel and air mixture into the combustion chamber. The amount of fuel and air is set to achieve a rich combustion. Taking an air-fuel ratio λ to be equal to 1 when a stochiometric ratio is present, λ will be less than 1 for a rich combustion. Preferably, λ is between 0.6 and 0.75.

Taking 0° as the crankshaft angle when the piston 11 is at top dead centre at the end of the compression stroke/start of the expansion stroke; the intake stroke lasts from 720° to 900°.

At FIG. 1b) a compression stroke is shown, from 900° to 1000° of crankshaft rotation, during the majority of which both the valves 12 and 14 are closed and the mixture of fuel and air is compressed.

At 0° the compressed mixture is ignited by the spark plug 13. The ignited gases expand in a power stroke, urging the piston away from the valves, as can be seen in FIG. 1c). At the end of the expansion stroke the exhaust valve 14 is opened briefly to allow some combusted gases to be exhausted to atmosphere, (see FIG. 1d) but the valve 14 is closed before the piston reaches its Bottom Dead Centre position.

Next, the combusted gases are compressed (see FIG. 1e) and 1f) in what would be the exhaust stroke in an Otto cycle, from 180° to 360° of crankshaft rotation. The inlet valve 12 is opened briefly at the start of this stroke (see FIG. 1e). Pressurised charge air (e.g. pressurised by an engine-driven supercharger or by a turbocharger) is introduced into the cylinder 11 against the in-cylinder back pressure.

Combustion then occurs in the cylinder, in the form of a homogeneous charge compression ignition (HCCI). The mixture of fuel, air and combusted gases is ignited by compression, without the use of a spark plug. At this time, the air-fuel ratio is lean, and λ is greater than 1. preferably, λ is between 1.35 and 1.55.

The combusted gases expand in a second power stroke shown in FIG. 1g), between 360° and 540° of crankshaft rotation. At the end of this stroke, the exhaust valve 14 is opened and then kept open for at least the majority of an exhaust stroke shown in FIG. 1h), so that the combusted gases are exhausted to atmosphere.

The six stroke cycle is therefore completed and is repeated.

The rich mixtures resulting from the chosen λ for the spark combustion of FIG. 1c) results in NOx emissions which are very low (less than 80 ppm) but HC emissions which are very high (greater than 7000 ppm). The second combustion of FIG. 1g) is very lean, since the charge mixture is highly diluted by the retained exhaust gases. This results in a low combustion temperature, which is below the threshold level for formation of oxides of Nitrogen (NOx), but high enough to provide complete fuel oxidation. The two-stage combustion results in low levels of NOx emitted, i.e. less than 100 ppm and low levels of hydrocarbons emitted i.e. less than 100 ppm.

The described six stroke cycle may increase the output power by approximately 100% compared with a conventional four stroke engine. The fuel consumption is reduced by approximately 15% compared to a conventional port fuelled engine, and reduced by approximately 8% compared to a conventional direct injection engine. The power increase is due to two combustion events being performed in each cylinder during a single six stroke cycle. The fuel reduction results from improved thermodynamics and higher fuel conversion efficiency.

In order to ensure that the air-fuel ratio for the second combustion is within the range specified above, additional fuel may be supplied (when the inlet valve 11 opens in FIG. 1e))to the cylinder after the first combustion.

It is also possible to provide a three-stage combustion cycle, having eight strokes. This is achieved by repeating the second stage combustion (i.e. the two strokes shown in FIGS. 1e), 1f) and 1g)) at the end of the above six stroke cycle. This results in a eight stroke cycle having an modified conventional four stroke cycle, followed by a second stage of the two-stroke cycle, followed by a third stage of the two-stroke cycle. The cycle therefore contains one spark ignition combustion and two HCCI combustions. The second stage of the two-stroke cycle may be treated as modular, and can be repeated more than once after the conventional four stroke cycle. Fuel may be supplied in the compression stroke of the third stage.

The advantage of adding the third stage is an increase in power output whilst keeping emissions substantially the same as those obtained from the two-stage process.

It is further possible to operate a four, five, six or more stage combustion, respectively having ten, twelve, fourteen or more strokes. These cycles again start with a modified conventional four stroke cycle, with increasing numbers of additional two stroke cycles added. An additional supply of fuel is provided to each stage except the last stage, although fuel may optionally be supplied to the last stage.

The pressure charging of the fresh charge, air may be provided by a means external to the engine, for example a super charger. The pressure charging may also be achieved by some of the cylinders of the engine working as compressors. The increase in power produced by carrying out the cycle of the present invention allows the engine to work on a reduced number of cylinders. For example, a four cylinder engine may function with two cylinders performing internal combustion according to a six stroke cycle and two cylinders working as compressors.

The combustion process described in FIG. 1 above is suitable for a port-fuelled engine. FIG. 2 shows an engine with a direct fuel injector 15. The operation of the engine is largely as described above, save that in the intake stroke of FIG. 1a) the inlet valve 12 admits only air into the combustion chamber (rather than a fuel/air mixture). The injector 15 injects fuel into the cylinder 11 during the first part of the compression stroke (as shown at FIG. 2a)). Although not shown in FIG. 2, it is possible that additional fuel could be injected during the compression of the combusted gases (FIG. 2g)) to assist the HCCI second-stage combustion.

In a further embodiment of the invention, the pressurised charged air required is provided from a reservoir (rather than from a supercharger or turbocharger).

The reservoir contains air pressurised by the engine. This is of particular use for a direct injection engine and can eliminate the need for a supercharger. This embodiment will now be described in greater detail with reference to FIG. 3.

The FIG. 3 embodiment is provided with an additional valve 16 connected by a first exhaust duct to an air reservoir (the exhaust valve 14 remains connected to an exhaust duct which leads to the atmosphere).

The above described operating cycle of FIG. 2 is modified to utilise the air reservoir. In the first compression stage (illustrated in FIGS. 3b), 3c), 3d)), the valve 16 is opened once the cylinder pressure reaches a certain value (i.e. part way through the stroke) and air is pumped via the valve 16 to the air reservoir in order to charge the air reservoir. The valve 16 is then closed before the fuel is injected by the direct injector (see FIG. 3d)).

In the second compression stage illustrated in FIGS. 3g) and 3h), the valve 16 opens in the early part of the compression stroke of FIG. 3g) to introduce pressure charged air from the air reservoir into the combustion chamber. The air from the air reservoir is at a higher pressure than the cylinder pressure, and so the air is forced into the engine cylinder.

The storing and use of air from an air reservoir may also be used for 8, 10 or 12 stroke cycles, adding additional two-stroke cycles as described above. For example, for a three-stage cycle, air is supplied to the engine from the reservoir twice, once into the compression stroke of the second stage and once into the compression stroke of the third stage. Air is stored in the air reservoir once in each cycle.

Although hydraulically actuated valves are described above, the valves could be operated by cams mounted on a camshaft for rotation therewith. The camshaft is connected (e.g. by a belt or chain—not shown) to a crankshaft driven to rotate by the pistons, which are connected to the crankshafts by connecting rods.

The cycle of the present invention can be operated using petrol as a fuel, or may alternatively be operated with gaseous fuels such as natural gas, methane or propane. An alcohol type fuel may alternatively be used, such as methanol or ethanol. Diesel may also be used as a fuel, and if used would not require a spark plug or a spark to cause combustion in the second stroke. The profiles of the intake valves and exhaust valves, and the air fuel ratio, may need to be adjusted to values typically used for that a fuel.

1. An internal combustion engine which operates repeatedly a multi-stage combustion process, the engine having a combustion chamber, supply means for supplying fuel and air to the combustion chamber and exhaust means for exhausting combusted gases from the combustion chamber, wherein:
during a first stage of combustion the supply means supplies fuel and air to the combustion chamber and the supplied fuel and air are combusted by a spark ignition Otto process;
then at least a majority of the combusted gases resulting from the first stage combustion are retained in the combustion chamber, additional air is supplied to the combustion chamber and the resulting mixture is combusted in a second combustion stage by homogeneous charge compression ignition; and
the mixture of fuel and air during the first stage combustion is a rich mixture (with an air-fuel ratio λ less than 1) and the mixture of fuel and air and combusted gases during the second stage of combustion is a weak mixture (with an air-fuel ratio λ greater than 1).

2. An internal combustion engine as claimed in claim 1 wherein:
at least a majority of the combusted gases resulting from the second stage combustion are retained in the combustion chamber and combusted in a third combustion stage by homogeneous charge compression ignition.

3. An internal combustion engine as claimed in claim 1 wherein the further combustion stage following the first combustion comprises a two-stroke process, in the first stroke of which compressed air is introduced into the combustion chamber to be mixed with the combusted gases already present and the mixture is then compressed and thereby ignited and in the second stroke of which the combustion gases expand.

4. An internal combustion engine as claimed in claim 3 wherein additionally in the first stroke of each further combustion stage the supply means supplies additional fuel to the combustion chamber.

5. An internal combustion engine as claimed in claim 3 wherein the supply means comprises an air compressor driven by the engine or by the exhaust gases flowing from the engine.

6. An internal combustion engine as claimed in claim 3 comprising additionally a reservoir for compressed air wherein some of the air compressed in the combustion chamber during the compression stroke of the first combustion stage is relayed to the reservoir for storage therein and wherein stored compressed air is relayed from the reservoir to the combustion chamber in the first stroke of the/each further combustion stage.

7. An internal combustion engine as claimed in claim 1 wherein the supply means comprises air supply means for supplying air to the combustion chamber and direct fuel injection means for separately injecting fuel directly into the combustion chamber.

8. An internal combustion engine as claimed in claim 1 wherein the mixture of fuel and air during the first stage combustion has an air-fuel ratio λ between 0.6 and 0.75 and the mixture of fuel and air during the/each subsequent stage of combustion has an air-fuel ratio λ between 1.335 and 1.55.

9. An internal combustion engine which operates repeatedly a multi-stage combustion process, the engine having a combustion chamber, supply means for supplying fuel and air to the combustion chamber and exhaust means for exhausting combusted gases from the combustion chamber, wherein:
during a first stage of combustion the supply means supplies fuel and air to the combustion chamber and the supplied fuel and air are combusted by a spark ignition Otto process;
then in each of a plurality of subsequent combustion stages at least a majority of the combusted gases resulting from the previous combustion are retained in the combustion chamber, additional air is supplied to the combustion chamber and the resulting mixture is combusted by homogeneous charge compression ignition, until after the last of the combustion stages the combusted gases are exhausted to atmosphere; and
the mixture of fuel and air during the first stage combustion is a rich mixture (with an air-fuel ratio λ less than 1) and the mixture of fuel and air and combusted gases during each subsequent stage of combustion is a weak mixture (with an air-fuel ratio λ greater than 1).

10. An internal combustion engine as claimed in claim 9 wherein each further combustion stage following the first combustion comprises a two-stroke process, in the first stroke of which compressed air is introduced into the combustion chamber to be mixed with the combusted gases already present and the mixture is then compressed and thereby ignited and in the second stroke of which the combustion gases expand.

11. An internal combustion engine as claimed in claim 10 wherein additionally in the first stroke of each further combustion stage the supply means supplies additional fuel to the combustion chamber.

12. An internal combustion engine as claimed in claim 10 wherein the supply means comprises an air compressor driven by the engine or by the exhaust gases flowing from the engine.

13. An internal combustion engine as claimed in claim 10 comprising additionally a reservoir for compressed air wherein some of the air compressed in the combustion chamber during the compression stroke of the first combustion stage is relayed to the reservoir for storage therein and wherein stored compressed air is relayed from the reservoir to the combustion chamber in the first stroke of each further combustion stage.

14. An internal combustion engine as claimed in claim 9 wherein the supply means comprises air supply means for supplying air to the combustion chamber and direct fuel injection means for separately injecting fuel directly into the combustion chamber.

15. An internal combustion engine as claimed in claim 9 wherein the mixture of fuel and air during the first stage combustion has an air-fuel ratio λ between 0.6 and 0.75 and the mixture of fuel and air during the/each subsequent stage of combustion has an air-fuel ratio λ between 1.335 and 1.55.

16. An internal combustion engine as claimed in claim 9 wherein each multi-stage combustion process comprises a number of strokes equal to four plus two times the number of subsequent stage of combustion following the first combustion stage.

17. An internal combustion engine which operates repeatedly a multi-stage combustion process, the engine having a combustion chamber, supply means for supplying fuel and air to the combustion chamber and exhaust means for exhausting combusted gases from the combustion chamber, wherein:
during a first stage of combustion the supply means supplies fuel and air to the combustion chamber and the supplied fuel and air are combusted by a compression ignition Diesel process;
then at least a majority of the combusted gases resulting from the first stage combustion are retained in the combustion chamber, additional air is supplied to the combustion chamber and the resulting mixture is combusted in a second combustion stage by homogeneous charge compression ignition; and
the mixture of fuel and air during the first stage combustion is a rich mixture (with an air-fuel ratio λ less than 1) and the mixture of fuel and air and combusted gases during the second stage of combustion is a weak mixture (with an air-fuel ratio λ greater than 1).

18. An internal combustion engine as claimed in claim 17 wherein:
at least a majority of the combusted gases resulting from the second stage combustion are retained in the combustion chamber and combusted in a third combustion stage by homogeneous charge compression ignition.

19. An internal combustion engine as claimed in claim 17 wherein the further combustion stage following the first combustion comprises a two-stroke process, in the first stroke of which compressed air is introduced into the combustion chamber to be mixed with the combusted gases already present and the mixture is then compressed and thereby ignited and in the second stroke of which the combustion gases expand.

20. An internal combustion engine as claimed in claim 19 wherein additionally in the first stroke of each further combustion stage the supply means supplies additional fuel to the combustion chamber.

21. An internal combustion engine as claimed in claim 19 wherein the supply means comprises an air compressor driven by the engine or by the exhaust gases flowing from the engine.

22. An internal combustion engine as claimed in claim 19 comprising additionally a reservoir for compressed air wherein some of the air compressed in the combustion chamber during the compression stroke of the first combustion stage is relayed to the reservoir for storage therein and wherein stored compressed air is relayed from the reservoir to the combustion chamber in the first stroke of the/each further combustion stage.

23. An internal combustion engine as claimed in claims 17 wherein the supply means comprises air supply means for supplying air to the combustion chamber and direct fuel injection means for separately injecting fuel directly into the combustion chamber.

24. An internal combustion engine as claimed in claim 17 wherein the mixture of fuel and air during the first stage combustion has an air-fuel ratio λ between 0.6 and 0.75 and the mixture of fuel and air during the/each subsequent stage of combustion has an air-fuel ratio λ between 1.335 and 1.55.

25. An internal combustion engine which operates repeatedly a multi-stage combustion process, the engine having a combustion chamber, supply means for supplying fuel and air to the combustion chamber and exhaust means for exhausting combusted gases from the combustion chamber, wherein:
during a first stage of combustion the supply means supplies fuel and air to the combustion chamber and the supplied fuel and air are combusted by a compression ignition Diesel process;
then in each of a plurality of subsequent combustion stages at least a majority of the combusted gases resulting from the previous combustion are retained in the combustion chamber, additional air is supplied to the combustion chamber and the resulting mixture is combusted by homogeneous charge compression ignition, until after the last of the combustion stages the combusted gases are exhausted to atmosphere; and
the mixture of fuel and air during the first stage combustion is a rich mixture (with an air-fuel ratio λ less than 1) and the mixture of fuel and air and combusted gases during each subsequent stage of combustion is a weak mixture (with an air-fuel ratio λ greater than 1).

26. An internal combustion engine as claimed in claim 25 wherein each further combustion stage following the first combustion comprises a two-stroke process, in the first stroke of which compressed air is introduced into the combustion chamber to be mixed with the combusted gases already present and the mixture is then compressed and thereby ignited and in the second stroke of which the combustion gases expand.

27. An internal combustion engine as claimed in claim 26 wherein additionally in the first stroke of each further combustion stage the supply means supplies additional fuel to the combustion chamber.

28. An internal combustion engine as claimed in claim 26 wherein the supply means comprises an air compressor driven by the engine or by the exhaust gases flowing from the engine.

29. An internal combustion engine as claimed in claim 26 comprising additionally a reservoir for compressed air wherein some of the air compressed in the combustion chamber during the compression stroke of the first combustion stage is relayed to the reservoir for storage therein and wherein stored compressed air is relayed from the reservoir to the combustion chamber in the first stroke of the/each further combustion stage.

30. An internal combustion engine as claimed in claim 25 wherein the supply means comprises air supply means for supplying air to the combustion chamber and direct fuel injection means for separately injecting fuel directly into the combustion chamber.

31. An internal combustion engine as claimed in claim 25 wherein the mixture of fuel and air during the first stage combustion has an air-fuel ratio λ between 0.6 and 0.75 and the mixture of fuel and air during the/each subsequent stage of combustion has an air-fuel ratio λ between 1.335 and 1.55.

32. An internal combustion engine as claimed in claim 25 wherein each multi-stage combustion process comprises a number of strokes equal to four plus two times the number of subsequent stages of combustion following the first combustion stage.
